(19) United States
(12) Patent Application Publication
(10) Pub. No.: US 2002/0075899 A1
(43) Pub. Date: Jun. 20, 2002

(54) Method and device for receiving and converting transmission signals transmitted according to different protocols

(76) Inventors: Fu-An Chuang, Taipei (TW); Su-Fang Chu, Taipei (TW)

Correspondence Address: BACON & THOMAS, 4th Floor, 625 Slaters Lane, Alexandria, VA, 22314, US

(21) Appl. No.: 09/737,480

(22) Filed: Dec. 18, 2000

(51) Int. Cl. H04J 3/16

(52) U.S. Cl. 370/467; 370/389

(57) ABSTRACT

Method for receiving and converting transmission signals transmitted according to different protocols, including steps of receiving a transmission signal, judging according to which protocol the transmission signal is transmitted and executing mapping operation corresponding to the transmission signal.

### BACKGROUND OF THE INVENTION

The present invention is related to a device and a method for receiving and converting transmission signals transmitted according to different protocols.

It is a trend to combine PC products with traditional domestic electric appliances. The derived electric appliances are so-called information domestic electric appliances.

In general, the traditional domestic electric appliances are controlled by remote controllers, while PC products are controlled by keyboards. In order to facilitate the use of PC products, remote controlling keyboards had been developed. However, the remote controlling keyboards and the remote controllers transmit signals which are encoded according to different protocols. Therefore, in case it is desired to enable an information domestic electric appliance to receive the signals transmitted by both remote controlling keyboard and the remote controller, there must be two measures for respectively receiving the signals transmitted by the remote controlling keyboard and the remote controller. This leads to increment of cost and lowers competitive ability.

### SUMMARY OF THE INVEIVTION

It is therefore a primary object of the present invention to provide a device and a method for receiving and converting transmission signals transmitted according to different protocols.

According to the above object, the method of the present invention for receiving and converting transmission signals transmitted according to different protocols includes steps of receiving a transmission signal, judging according to which protocol the transmission signal is transmitted and executing mapping operation corresponding to the transmission signal.

In the device of the present invention for receiving and converting transmission signals transmitted according to different protocols, the transmission signals come from a remote controller and a remote controlling keyboard. The device is mounted on an electronic product having a microprocessor unit. The device includes: a signal receiver serving to receive the transmission signals transmitted from the remote controller and the remote controlling keyboard; a determination circuit serving to judge whether the transmission signal comes from the remote controller or the remote controlling keyboard; and a mapping/outputting circuit which according to the result of judgement of the determination circuit executes mapping operation for the received transmission signal and outputs the mapped transmission signal to the microprocessor unit for excessive processing so as to control the responsive operation of the electronic product.

According to another embodiment of the present invention, the present invention includes a signal transmitting/receiving system including: at least two signal transmitting devices for transmitting transmission signals according to different protocols; and a signal receiving device for receiving and converting the transmission signals transmitted by the signal transmitting devices, the signal receiving device being mounted on an electronic product having a microprocessor unit, the signal receiving device including: a signal receiver for receiving the transmission signals transmitted from the two signal transmitting devices; a determination circuit for judging from which signal transmitting device the transmission signal is transmitted; and a mapping/outputting circuit which according to the result of judgement of the determination circuit executes mapping operation for the received transmission signal and outputs the mapped transmission signal to the microprocessor unit for excessive processing so as to control the responsive operation of the electronic product.

The present invention can be best understood through the following description and accompanying drawings wherein:

### BRIEF DESCRPTION OF THE DRAWINGS

FIG. 1 is a block diagram of the device of the present invention for receiving and converting transmission signals transmitted according to different protocols; and

FIG. 2 is a flow chart of the method of the present invention for receiving and converting transmission signals transmitted according to different protocols.

### DETAILED DESCRITION OF THE PREFERRED EMBODIMENTS

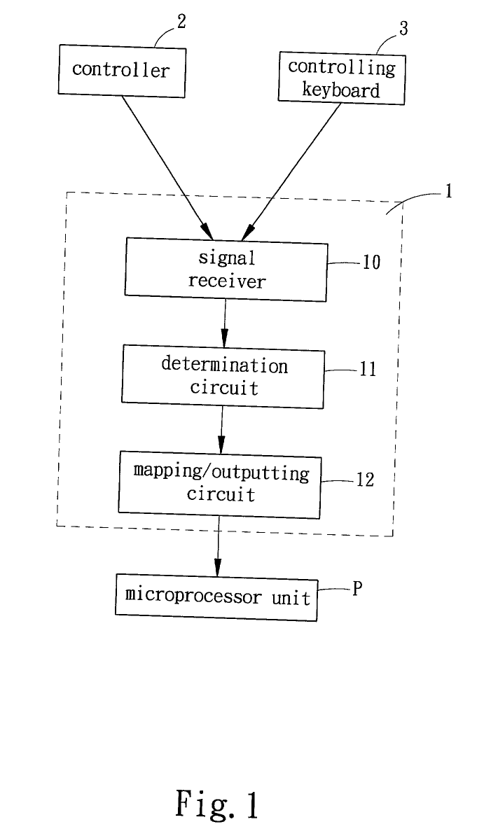

Please refer to FIG. 1. The device for receiving and converting signals transmitted according to different protocols of the present invention includes a signal receiving device 1. The signal receiving device 1 is mounted on an electronic product (not shown ) having a microprocessor unit P and electrically connected therewith.

The signal receiving device 1 includes a signal receiver 10, a determination circuit 11 and a mapping/outputting circuits 12.

The signal receiver 10 serves to receive signals transmitted from the remote controller 2 and the remote controlling keyboard 3 according to different protocols.

The determination circuit 11 is electrically connected with the signal receiver 10 for judging whether the received transmission signal comes from the remote controller 2 or the remote controlling keyboard 3.

The mapping/outputting circuit 12 is electrically connected with the determination circuit 11 for mapping the received transmission signal and outputting the mapped transmission signal to the microprocessor unit P of the electronic product.

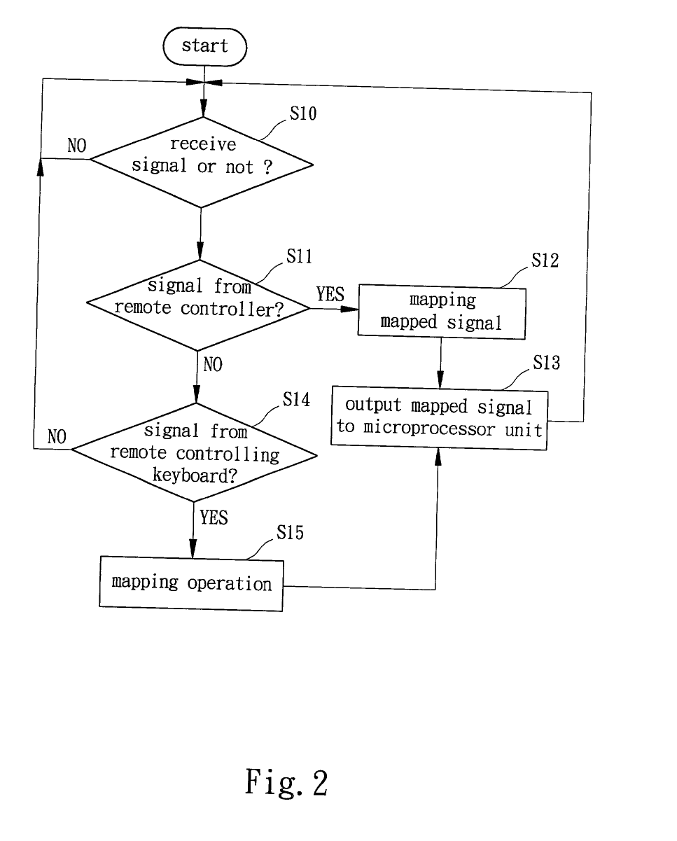

Please refer to FIG. 2. When one of the remote controller 2 and the remote controlling keyboard 3 transmits a transmission signal via a press key, in step S10, the signal receiver 10 of the signal receiving device 1 will receive the transmission signal. Then, in step S11, the determination circuit 11 judges whether the received transmission signal comes from the remote controller 2. If so, in step S12, the mapping/outputting circuit 12 will execute mapping operation and in step S13, the mapping/outputting circuit 12 will output the mapped transmission signal to the microprocessor unit P for successive processing so as to control the responsive operation of the electronic product. Otherwise, in step S14, the determination circuit 11 will judge whether the transmission signal comes from the remote controlling keyboard 3. If so, in step S15, the mapping/outputting circuit 12 will execute mapping operation and in step S13 output the mapped transmission signal to the microprocessor unit P for successive processing so as to control the responsive operation of the electronic product. Otherwise, the signal receiver 10 waits for the next signal.

It should be noted that the way by which the remote controller 2 and the remote controlling keyboard 3 transmit the signal and the mapping/outputting circuit 12 executes mapping operation pertains to prior art and will not be described herein.

The above embodiments are only used to illustrate the present invention, not intended to limit the scope thereof. Many modifications of the above embodiments can be made without departing from the spirit of the present invention.

What is claimed is:

1. Method for receiving and converting transmission signals transmitted according to different protocols, comprising steps of:
receiving a transmission signal;
judging according to which protocol the transmission signal is transmitted; and
executing mapping operation corresponding to the transmission signal.

2. Device for receiving and converting transmission signals transmitted according to different protocols, the transmission signals coming from a remote controller and a remote controlling keyboard, the device being mounted on an electronic product having a microprocessor unit, said device comprising:
a signal receiver serving to receive the transmission signals transmitted from the remote controller and the remote controlling keyboard;
a determination circuit serving to judge whether the transmission signal comes from the remote controller or the remote controlling keyboard; and
a mapping/outputting circuit which according to the result of judgement of the determination circuit executes mapping operation for the received transmission signal and outputs the mapped transmission signal to the microprocessor unit for excessive processing so as to control the responsive operation of the electronic product.

3. Signal transmitting/receiving system comprising:
at least two signal transmitting devices for transmitting transmission signals according to different protocols; and
a signal receiving device for receiving and converting the transmission signals transmitted by the signal transmitting devices, the signal receiving device being mounted on an electronic product having a microprocessor unite the signal receiving device including:
a signal receiver for receiving the transmission signals transmitted from the two signal transmitting devices;
a determination circuit for judging from which signal transmitting device the transmission signal is transmitted; and
a mapping/outputting circuit which according to the result of judgement of the determination circuit executes mapping operation for the received transmission signal and outputs the mapped transmission signal to the microprocessor unit for excessive processing so as to control the responsive operation of the electronic product.
